(19) United States
(12) Patent Application Publication
(10) Pub. No.: US 2014/0236986 A1
(43) Pub. Date: Aug. 21, 2014

(54) NATURAL LANGUAGE DOCUMENT SEARCH

(71) Applicant: Apple Inc., Cupertino, CA (US)

(72) Inventor: Angela GUZMAN, San Mateo, CA (US)

(73) Assignee: APPLE INC., Cupertino, CA (US)

(21) Appl. No.: 14/178,037

(22) Filed: Feb. 11, 2014

Related U.S. Application Data
(60) Provisional application No. 61/767,684, filed on Feb. 21, 2013.

(51) Int. Cl. G06F 17/30

(52) U.S. Cl. CPC G06F 17/30011
USPC 707/769

(57) ABSTRACT

A method for searching for documents is provided. The method is performed at an electronic device including a display device, one or more processors, and memory storing instructions for execution by the one or more processors. The method includes displaying a text input field on the display device and receiving a natural language text input in the text input field. The method also includes processing the natural language text input to derive search parameters for a document search. The search parameters include one or more document attributes and one or more values corresponding to each document attribute. The method also includes displaying, in a display region different from the text input field, the one or more document attributes and the one or more values corresponding to each document attribute.

### CROSS-REFERENCE TO RELATED APPLICATIONS

This Application claims the benefit of U.S. Provisional Application No. 61/767,684, filed on Feb. 21, 2013, entitled NATURAL LANGUAGE DOCUMENT SEARCH, which is hereby incorporated by reference in its entity for all purposes.

### TECHNICAL FIELD

The disclosed implementations relate generally to document searching, and more specifically, to a method, system, and graphical user interface for natural language document searching.

### BACKGROUND

As computer use has increased, so too has the quantity of documents that are created and stored on (or otherwise accessible to) computers and other electronic devices. For example, users may have hundreds or thousands of saved emails, word processing documents, spreadsheets, photographs, or letters (or indeed any other document that includes or is associated with textual data or metadata). However, document search functions can be difficult and cumbersome. For example, some search functions accept structured search queries, while others accept natural language inputs. Adding to the confusion, it is not always clear to a user what type of input or search syntax a particular search function is configured to accept.

Moreover, advanced search functions, such as those that accept structured queries, may be confusing and difficult to use, while more basic ones may be too simplistic to provide the desired search results. For example, when a user searches in an email program for all emails containing the words “birthday party,” this basic search function will simply return all documents that include an identified word or words. However, this search may locate many irrelevant emails, such as those relating to birthday parties from several years ago. On the other hand, more powerful search functions may allow the user to provide more specific details about the documents that they are seeking, such as by accepting a structured search query that specifies particular document attributes and values for those attributes. For example, a user may create a search query that constrains the results to those emails with the words “birthday party” in the body of the email, that were received on a certain date (or within a certain date range), and that were sent by a particular person. The search query for this search may look something like:
Body: “birthday party”; Date: 12/30/12-1/30/13; From: “Harriet Michaels”
   However, to create this query, the user must understand the particular syntax of the email program and know how to create a structured search query that will result in only the intended emails being returned (or so that the search is limited to the appropriate set of emails). Even if the email program allows users to enter individual values into discrete inputs fields (e.g., by providing discrete input fields for “date,” “from,” “body,” etc.), the user still has to navigate between each input field and populate them individually, which can be cumbersome and time consuming.

Accordingly, it would be advantageous to provide a better way to search for documents, such as emails, using natural language text inputs.

### SUMMARY

The implementations described below provide systems, methods, and graphical user interfaces for natural language document searching. In particular, a document search function in accordance with the disclosed ideas receives a natural language text input, and then performs natural language processing on the text input to derive specific search parameters, such as document attributes, and values corresponding to the attributes. The document attributes and corresponding values are then displayed to the user in a pop-up window or other appropriate user interface region. For example, a user enters a natural language search query, such as “find emails from Harriet Michaels from last month about her birthday party,” and discrete search parameters are derived from this input and displayed to the user. The user can then review the search parameters, edit or remove them as desired, or even add to them. Thus, document searching is provided that provides the ease of a natural language searching, but with the level of detail and control of a structured-language search function.

Some implementations provide a method for searching for documents. The method is performed at an electronic device including a display device, one or more processors, and memory storing instructions for execution by the one or more processors. The method includes displaying a text input field on the display device; receiving a natural language text input in the text input field; processing the natural language text input to derive search parameters for a document search, the search parameters including one or more document attributes and one or more values corresponding to each document attribute; and displaying, in a display region different from the text input field, the one or more document attributes and the one or more values corresponding to each document attribute.

In some implementations, processing the natural language text input includes sending the natural language text input to a server system remote from the electronic device; and receiving the search parameters from the server system.

In some implementations, processing the natural language text input and displaying the one or more document attributes and the one or more values begins prior to receiving the end of the natural language text input.

In some implementations, the method further includes receiving a first user input corresponding to a request to delete one of the document attributes or one of the values. In some implementations, the method further includes receiving a second user input corresponding to a request to edit one of the document attributes or one of the values. In some implementations, the method further includes receiving a third user input corresponding to a request to add an additional document attribute. In some implementations, the method further includes, in response to the third user input, displaying a list of additional document attributes; receiving a selection of one of the displayed additional document attributes; displaying the selected additional document attribute in the display region; and receiving an additional value corresponding to the selected additional document attribute.

In some implementations, the one or more document attributes include at least one field restriction operator. In some implementations, the field restriction operator is selected from the group consisting of: from; to; subject; body; cc; and bcc. In some implementations, the one or more document attributes are selected from the group consisting of: date sent; sent before; sent after; sent between; received before; received after; received between; attachment; read; unread; flagged; document location; and document status.

In accordance with some implementations, an electronic device is provided, the electronic device including a user interface unit configured to display a text input field on a display device associated with the electronic device; an input receiving unit configured to receive a natural language text input entered into the text input field; and a processing unit coupled to the user interface unit and the input receiving unit, the processing unit configured to: process the natural language text input to derive search parameters for a document search, the search parameters including one or more document attributes and one or more values corresponding to each document attribute; and instruct the user interface unit to display, in a display region different from the text input field, the one or more document attributes and the one or more values corresponding to each document attribute.

In accordance with some implementations, a computer-readable storage medium (e.g., a non-transitory computer readable storage medium) is provided, the computer-readable storage medium storing one or more programs for execution by one or more processors of an electronic device, the one or more programs including instructions for performing any of the methods described herein.

In accordance with some implementations, an electronic device (e.g., a portable electronic device) is provided that comprises means for performing any of the methods described herein.

In accordance with some implementations, an electronic device (e.g., a portable electronic device) is provided that comprises a processing unit configured to perform any of the methods described herein.

In accordance with some implementations, an electronic device (e.g., a portable electronic device) is provided that comprises one or more processors and memory storing one or more programs for execution by the one or more processors, the one or more programs including instructions for performing any of the methods described herein.

In accordance with some implementations, an information processing apparatus for use in an electronic device is provided, the information processing apparatus comprising means for performing any of the methods described herein.

In accordance with some implementations, a graphical user interface is provided on a portable electronic device or a computer system with a display, a memory, and one or more processors to execute one or more programs stored in the memory, the graphical user interface comprising user interfaces displayed in accordance with any of the methods described herein.

### BRIEF DESCRIPTION OF THE DRAWINGS

FIG. 1 is a block diagram illustrating a computer environment in which a document search function may be implemented, in accordance with some implementations.

FIG. 2 is a block diagram illustrating a computer system, in accordance with some implementations.

FIGS. 3A-3B are flow charts illustrating a method for searching for documents, in accordance with some implementations.

FIGS. 4A-4E illustrate exemplary user interfaces associated with performing document searching, in accordance with some implementations.

FIG. 5 illustrates a functional block diagram of an electronic device, in accordance with some implementations.

Like reference numerals refer to corresponding parts throughout the drawings.

### DESCRIPTION OF IMPLEMENTATIONS

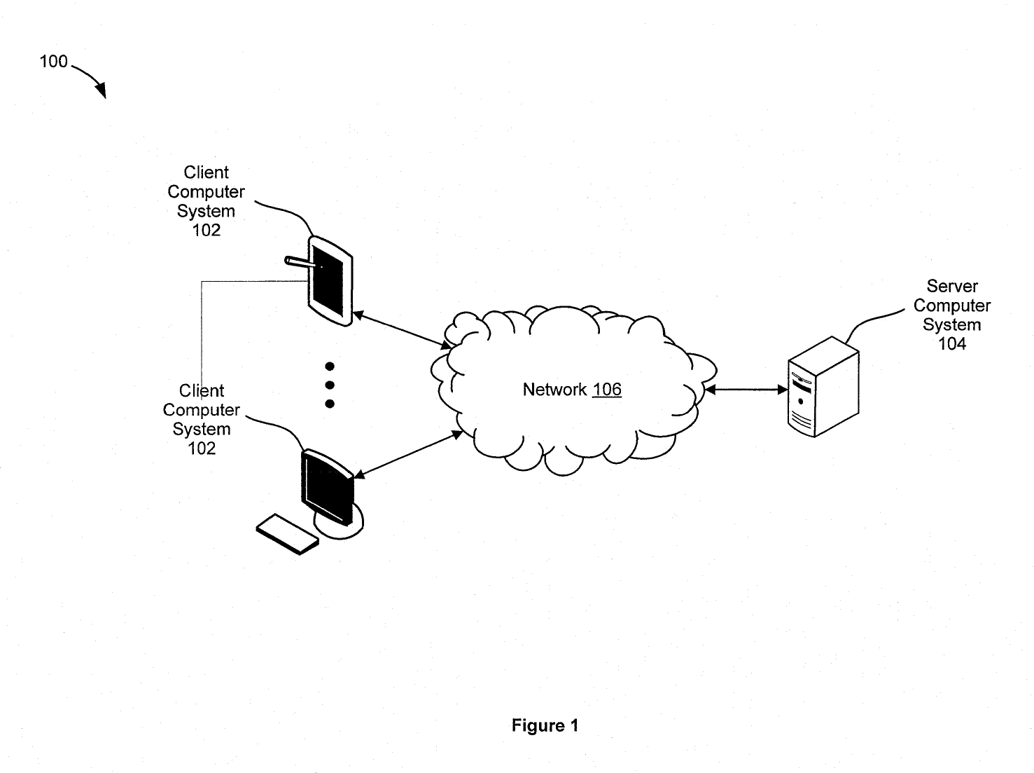

FIG. 1 illustrates a computer environment 100 in which a document search function may be implemented. The computer environment 100 includes client computer system(s) 102, and server computer system(s) 104 (sometimes referred to as client computers and server computers, respectively), connected via a network 106 (e.g., the Internet). Client computer systems 102 include, but are not limited to, laptop computers, desktop computers, tablet computers, handheld and/or portable computers, PDAs, cellular phones, smartphones, video game systems, digital audio players, remote controls, watches, televisions, and the like.

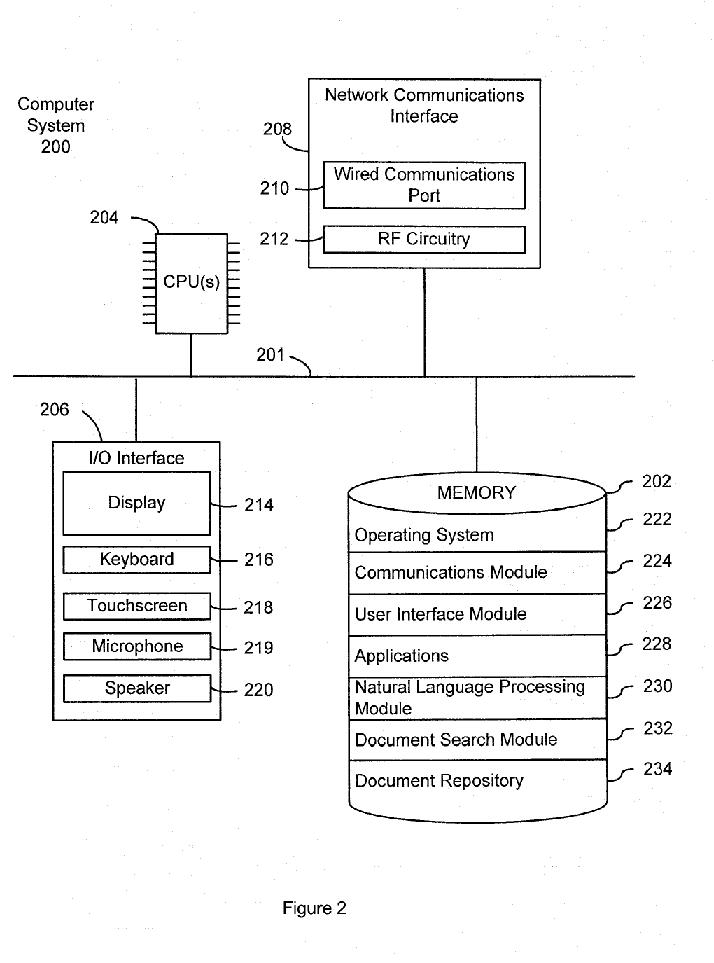

As described in more detail with respect to FIG. 2, client computers 102 and/or server computers 104 provide hardware, programs, and/or modules to enable a natural language document search function. In some cases, the document search function is configured to search for and/or retrieve documents from a corpus of documents stored at the client computer 102, the server computer 104, or both. For example, in some implementations, a user enters a natural language search input into the client computer 102, and the search function retrieves documents stored locally on the client computer 102 (e.g., on a hard drive associated with the client computer 102). In some implementations, the search function retrieves documents (and/or links to documents) stored on a server computer 104 that is remote from the client computer 102.

Moreover, in some implementations, the client computer 102 performs all of the operations associated with performing a document search alone (i.e., without communicating with a server computer 104). In some implementations, it works in conjunction with a server computer 104. For example, in some implementations, a natural language text input may be received at the client computer 102 and sent to the server computer 104 where the text input is processed to derive search parameters. In other implementations, the client computer 102 performs the natural language processing to derive search parameters from the natural language input, and the search parameters are sent to the server computer 104, which performs the document search and returns documents (and/or links to documents) that satisfy the search criteria.

FIG. 2 is a block diagram depicting a computer system 200 in accordance with some implementations. In some implementations, the computer system 200 represents a client computer system (e.g., the client computer system 102, FIG. 1), such as a laptop/desktop computer, tablet computer, smart phone, or the like. In some implementations, the computer system 200 represents a server computer system (e.g., the server computer system 104, FIG. 1). In some implementations, the components described as being part of the computer system 200 are distributed across multiple client computers 102, server computers 104, or any combination of client and server computers.

Moreover, the computer system 200 is only one example of a suitable computer system, and some implementations will have fewer or more components, may combine two or more components, or may have a different configuration or arrangement of the components than those shown in FIG. 2. The various components shown in FIG. 2 may be implemented in hardware, software, or a combination of hardware and software, including one or more signal processing and/or application specific integrated circuits.

Returning to FIG. 2, in some implementations, the computer system 200 includes memory 202 (which may include one or more computer readable storage mediums), one or more processing units (CPUs) 204, an input/output (I/O) interface 206, and a network communications interface 208. These components may communicate over one or more communication buses or signal lines 201. Communication buses or signal lines 201 may include circuitry (sometimes called a chipset) that interconnects and controls communications between system components.

The network communications interface 208 includes wired communications port 210 and/or RF (radio frequency) circuitry 212. Network communications interface 208 (in some implementations, in conjunction with wired communications port 210 and/or RF circuitry 212) enables communication with networks, such as the Internet, also referred to as the World Wide Web (WWW), an intranet and/or a wireless network, such as a cellular telephone network, a wireless local area network (LAN) and/or a metropolitan area network (MAN), and other devices. In some implementations, the network communications interface 208 facilitates communications between computer systems, such as between client and server computers. Wired communications port 210 receives and sends communication signals via one or more wired interfaces. Wired communications port 210 (e.g., Ethernet, Universal Serial Bus (USB), FIREWIRE, etc.) is adapted for coupling directly to other devices or indirectly over a network (e.g., the Internet, wireless LAN, etc.). In some implementations, wired communications port 210 is a multi-pin (e.g., 30-pin) connector that is the same as, or similar to and/or compatible with the 30-pin connector used on Applicant's IPHONE®, IPOD TOUCH®, and IPAD® devices. In some implementations, the wired communications port is a modular port, such as an RJ type receptacle.

The radio Frequency (RF) circuitry 212 receives and sends RF signals, also called electromagnetic signals. RF circuitry 212 converts electrical signals to/from electromagnetic signals and communicates with communications networks and other communications devices via the electromagnetic signals. RF circuitry 212 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. Wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol.

The I/O interface 206 couples input/output devices of the computer system 200, such as a display 214, a keyboard 216, a touch screen 218, a microphone 219, and a speaker 220 to the user interface module 226. The I/O interface 206 may also include other input/output components, such as physical buttons (e.g., push buttons, rocker buttons, etc.), dials, slider switches, joysticks, click wheels, and so forth.

The display 214 displays visual output to the user. The visual output may include graphics, text, icons, video, and any combination thereof (collectively termed “graphics”). In some implementations, some or all of the visual output may correspond to user-interface objects. For example, in some implementations, the visual output corresponds to text input fields and any other associated graphics and/or text (e.g., for receiving and displaying natural language text inputs corresponding to document search queries) and/or to text output fields and any other associated graphics and/or text (e.g., results of natural language processing performed on natural language text inputs). In some implementations, the display 214 uses LCD (liquid crystal display) technology, LPD (light emitting polymer display) technology, LED (light emitting diode) technology, OLED technology, or any other suitable technology or output device.

The keyboard 216 allows a user to interact with the computer system 200 by inputting characters and controlling operational aspects of the computer system 200. In some implementations, the keyboard 216 is a physical keyboard with a fixed key set. In some implementations, the keyboard 216 is a touchscreen-based, or “virtual” keyboard, such that different key sets (corresponding to different alphabets, character layouts, etc.) may be displayed on the display 214, and input corresponding to selection of individual keys may be sensed by the touchscreen 218.

The touchscreen 218 has a touch-sensitive surface, sensor or set of sensors that accepts input from the user based on haptic and/or tactile contact. The touchscreen 218 (along with any associated modules and/or sets of instructions in memory 202) detects contact (and any movement or breaking of the contact) on the touchscreen 218 and converts the detected contact into interaction with user-interface objects (e.g., one or more soft keys, icons, web pages or images) that are displayed on the display 214.

The touchscreen 218 detects contact and any movement or breaking thereof using any of a plurality of suitable touch sensing technologies, including but not limited to capacitive, resistive, infrared, and surface acoustic wave technologies, as well as other proximity sensor arrays or other elements for determining one or more points of contact with the touchscreen 218. In an exemplary implementation, projected mutual capacitance sensing technology is used, such as that found in Applicant's IPHONE®, IPOD TOUCH®, and IPAD® devices.

Memory 202 may include high-speed random access memory and may also include non-volatile and/or non-transitory computer readable storage media, such as one or more magnetic disk storage devices, flash memory devices, or other non-volatile solid-state memory devices. In some implementations, memory 202, or the non-volatile and/or non-transitory computer readable storage media of memory 202, stores the following programs, modules, and data structures, or a subset thereof: operating system 222, communications module 224, user interface module 226, applications 228, natural language processing module 230, document search module 232, and document repository 234.

The operating system 222 (e.g., DARWIN, RTXC, LINUX, UNIX, IOS, OS X, WINDOWS, or an embedded operating system such as VXWORKS) includes various software components and/or drivers for controlling and managing general system tasks (e.g., memory management, storage device control, power management, etc.) and facilitates communication between various hardware and software components.

The communications module 224 facilitates communication with other devices over the network communications interface 208 and also includes various software components for handling data received by the RF circuitry 212 and/or the wired communications port 210.

The user interface module 226 receives commands and/or inputs from a user via the I/O interface (e.g., from the keyboard 216 and/or the touchscreen 218), and generates user interface objects on the display 214. In some implementations, the user interface module 226 provides virtual keyboards for entering text via the touchscreen 218.

Applications 228 may include programs and/or modules that are configured to be executed by the computer system 200. In some implementations, the applications include the following modules (or sets of instructions), or a subset or superset thereof:
contacts module (sometimes called an address book or contact list);
telephone module;
video conferencing module;
e-mail client module;
instant messaging (IM) module;
workout support module;
camera module for still and/or video images;
image management module;
browser module;
calendar module;
widget modules, which may include one or more of: weather widget, stocks widget, calculator widget, alarm clock widget, dictionary widget, and other widgets obtained by the user, as well as user-created widgets;
widget creator module for making user-created widgets;
search module;
media player module, which may be made up of a video player module and a music player module;
notes module;
map module; and/or
online video module.

Examples of other applications 228 that may be stored in memory 202 include word processing applications, image editing applications, drawing applications, presentation applications, JAVA-enabled applications, encryption, digital rights management, voice recognition, and voice replication applications.

The natural language processing (NLP) module 230 processes natural language text inputs to derive search parameters for a document search. In some implementations, the search parameters correspond to document attributes and values for those attributes. For example, the NLP module 230 processes a natural language text input entered by a user into a text input field of a search function and identifies document attributes and corresponding values that were intended by the natural language text input. In some implementations, the NLP module 230 infers one or more of the document attributes and the corresponding values from the natural language input.

The document search module 232 searches and/or facilitates searching of a corpus of documents (e.g., documents stored in the document repository 234). In some implementations, the document search module 232 searches the corpus of documents for documents that satisfy a set of search parameters, such as those derived from a natural language input by the NLP module 230. In some implementations, the document search module 232 returns documents, portions of documents, information about documents (e.g., document metadata) and/or links to documents, which are provided to the user as results of the search. Natural language processing techniques are described in more detail in commonly owned U.S. Pat. No. 5,608,624 and U.S. patent application Ser. No. 12/987,982, both of which are hereby incorporated by reference in their entireties.

The document repository 234 stores documents, portions of documents, information about documents (e.g., document metadata), links to and/or addresses of remotely stored documents, and the like. The search module 232 accesses the document repository 234 to identify documents that satisfy a set of search parameters. The document repository 234 can include different types of documents, including emails, word processing documents, spreadsheets, photographs, images, videos, audio (e.g., music, podcasts, etc.), etc. In some implementations, the documents stored in the document repository 234 include text (such as an email or word processing document) or are associated with text (such as photos or audio files associated with textual metadata). In some implementations, metadata includes data that can be searched using a structured query (e.g., attributes and values). In some implementations, metadata is generated and associated with a file automatically, such as when a camera associates date, time, and geographical location information with a photograph when it is taken, or when a program automatically identifies subjects in a photograph using face recognition techniques and associates names of the subjects with the photo.

In some implementations, the document repository 234 includes one or more indexes. In some implementations, the indexes include data from the documents, and/or data that represents and/or summarizes the documents and/or relationships between respective documents.

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise re-arranged in various implementations. In some implementations, memory 202 may store a subset of the modules and data structures identified above. Furthermore, memory 202 may store additional modules and data structures not described above. Moreover, the above identified modules and applications may be distributed among multiple computer systems, including client computer system(s) 102 and server computer system(s) 104. Data and functions may be distributed among the clients and servers in various ways depending on considerations such as processing speed, communication speed and/or bandwidth, data storage space, etc.

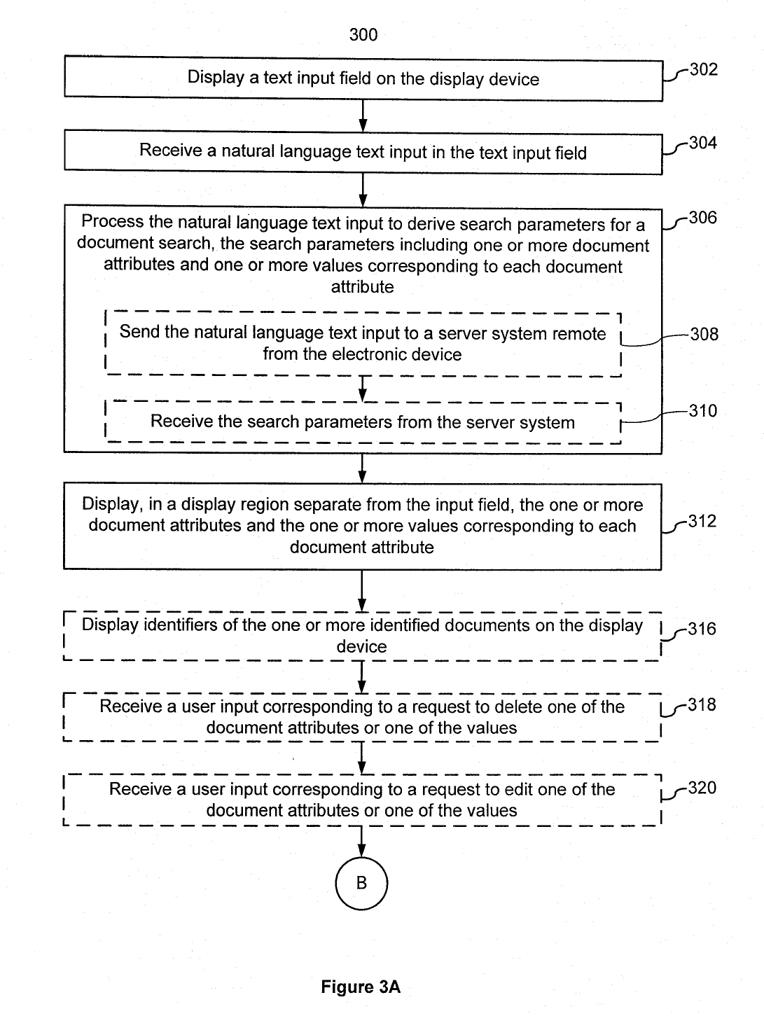

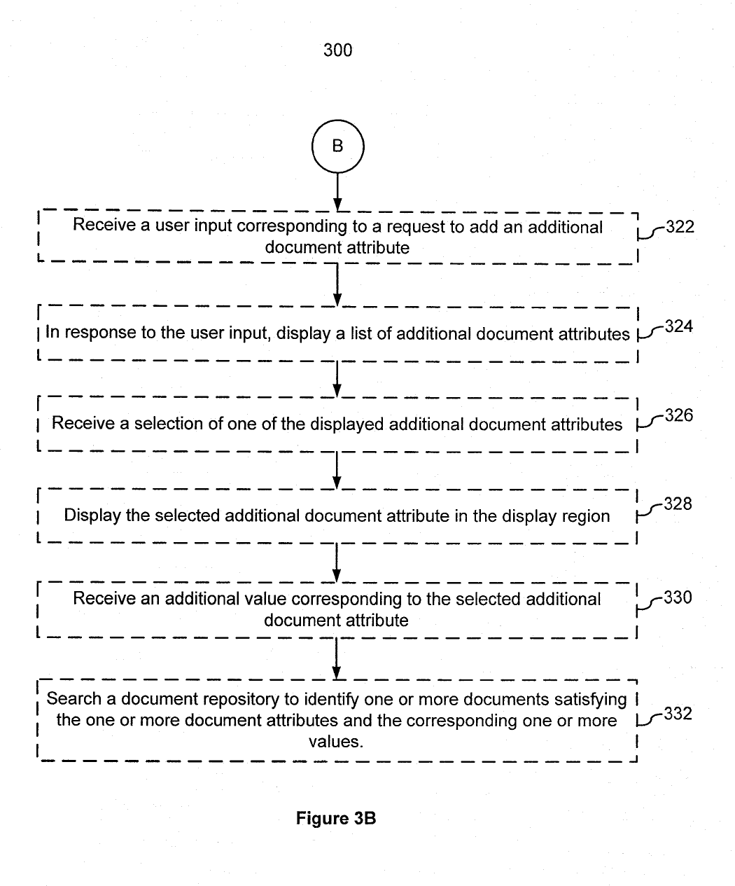

FIGS. 3A-3B are flow diagrams illustrating a method 300 for searching for documents, according to certain implementations. The methods are, optionally, governed by instructions that are stored in a computer memory or non-transitory computer readable storage medium (e.g., memory 202 of the computer system 200) and that are executed by one or more processors of one or more computer systems, such as the computer system 200 (which, in various implementations, represents a client computer system 102, a server computer system 104, or both). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. In various implementations, some operations in each method may be combined and/or the order of some operations may be changed from the order shown in the figures. Also, in some implementations, operations shown in separate figures and/or discussed in association with separate methods may be combined to from other methods, and operations shown in the same figure and/or discussed in association with the same method may be separated into different methods. Moreover, in some implementations, one or more operations in the methods are performed by modules of the computer system 200, including, for example, the natural language processing module 230, the document search module 232, the document repository 234, and/or any sub modules thereof.

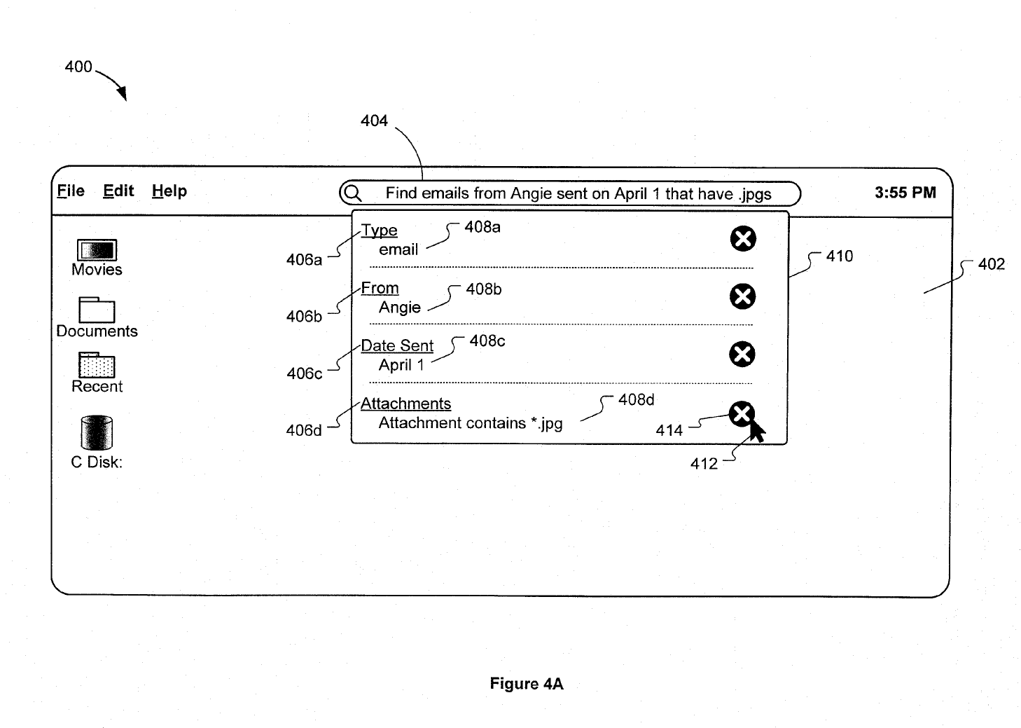

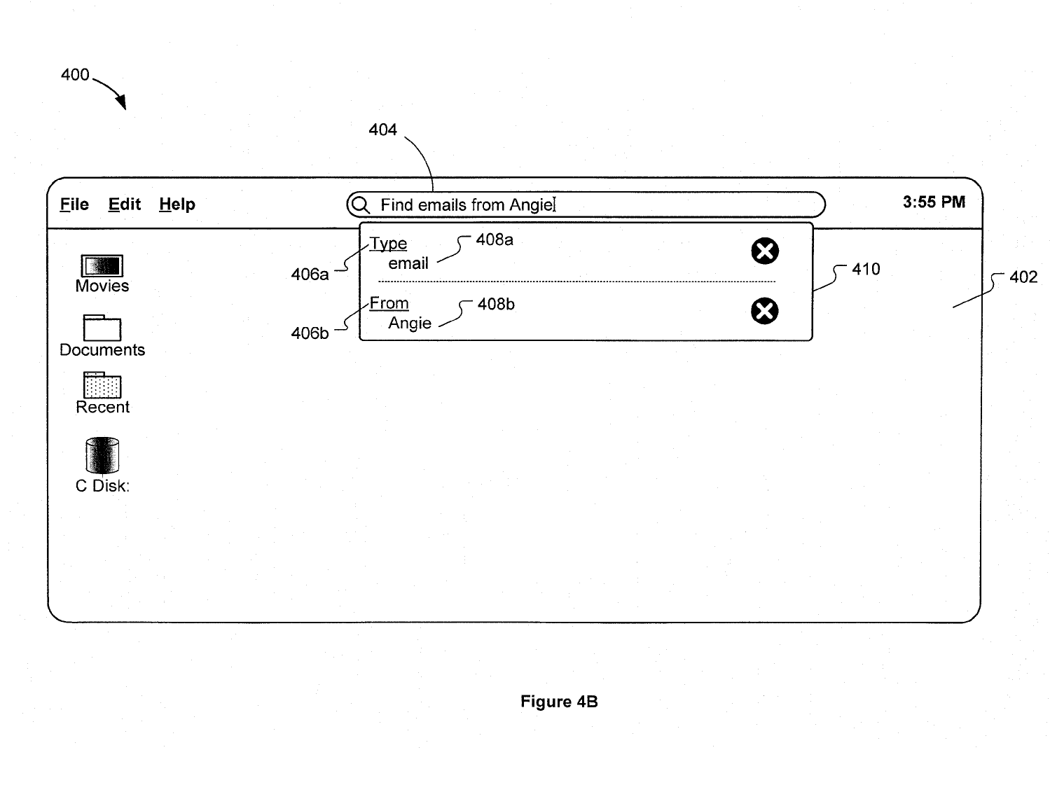

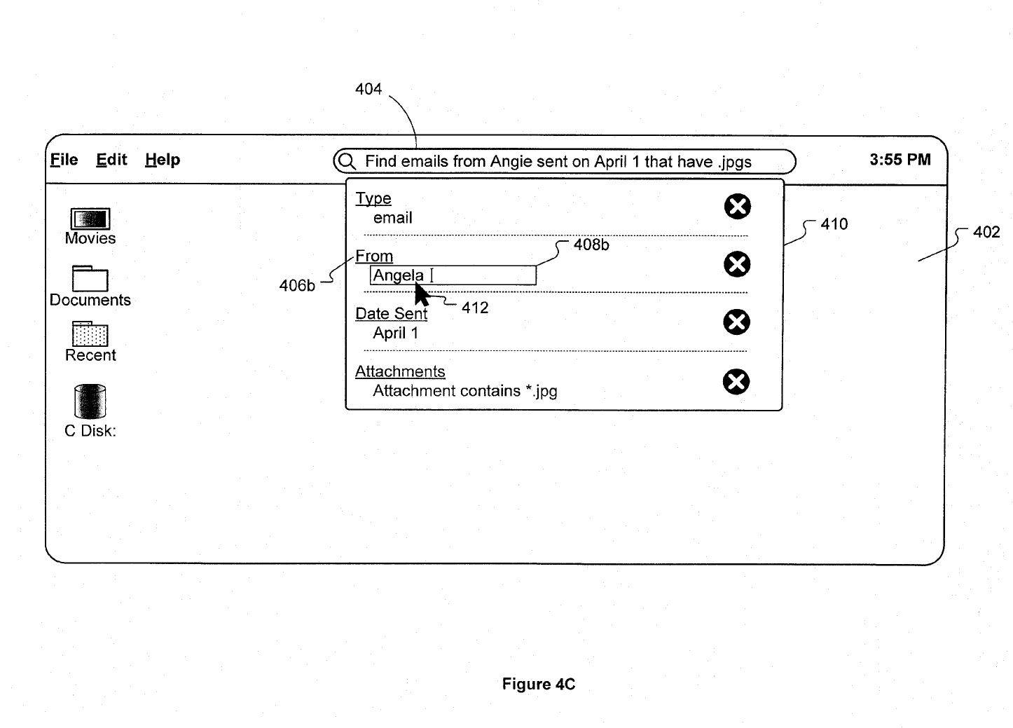

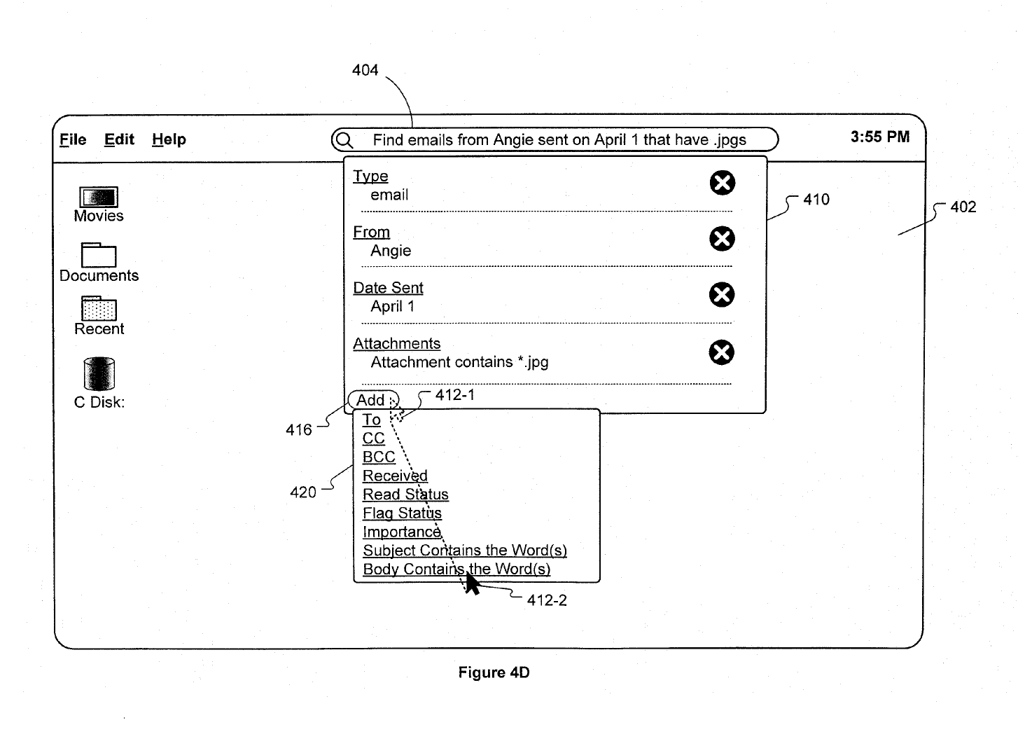

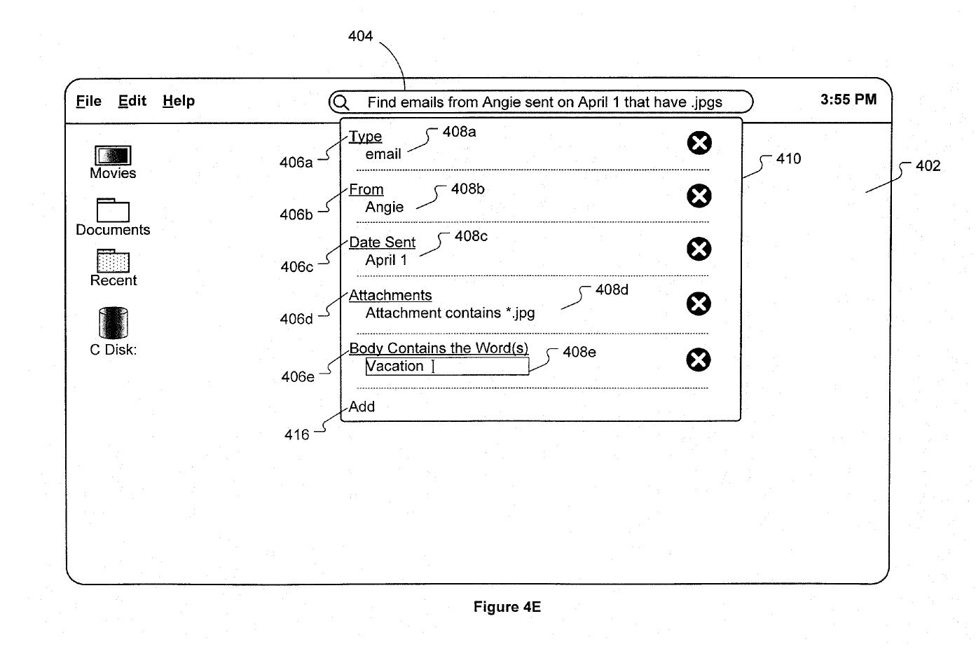

FIG. 3A illustrates a method 300 for searching for documents, according to some implementations. In some implementations, the method 300 is performed at an electronic device including a display device, one or more processors and memory storing instructions for execution by the one or more processors (e.g., the computer system 200). Where appropriate, the following discussion also refers to FIGS. 4A-4E, which illustrate exemplary user interfaces associated with performing document searching, in accordance with some implementations.

The electronic device displays a text input field on the display device (302) (e.g., the text input field 404, FIG. 4A). In some implementations, the text input field is graphically and/or programmatically associated with a particular application (e.g., an email application, photo organizing/editing application, word processing application, etc.). As a specific example, in some implementations, the text input field is displayed as part of a search feature in an email application (e.g., APPLE MAIL, MICROSOFT OUTLOOK, etc.). In some implementations, the text input field is graphically and/or programmatically associated with a file manager (e.g., Apple Inc.'s FINDER).

In some implementations, searches are automatically constrained based on the context in which the input field is displayed. For example, when the search input field is displayed in association with an email application (e.g., in a toolbar of an email application), the search is limited to emails. In another example, when the search input field is displayed in association with a file manager window that is displaying the contents of a particular folder (or other logical address), the search is limited to that folder (or logical address). In some implementations, the text input field is associated generally with a computer operating system (e.g., the operating system 222, FIG. 2), and not with any one specific application, document type, or storage location. For example, as shown in FIG. 4A, the text input field 404 is displayed in a desktop environment 402 of a graphical user interface of an operating system, indicating to the user that it can be used to search for documents from multiple applications, locations, etc.

The electronic device receives a natural language text input in the text input field (304). A natural language text input may be any text, and does not require any specific syntax or format. Thus, a user can search for a document (or set of documents) with a simple request. For example, as shown in FIG. 4A, the request “Find emails from Angie sent on April that have jpgs” has been entered into the text input field 404. As described below in conjunction with step (306), the text input is processed using natural language processing techniques to determine a set of search parameters. Because natural language processing is applied to the textual input, any input format and/or syntax may be used. For example, a user can enter a free-form text string such as “emails from Angie with pictures,” or “from angie with jpgs,” or even a structured search string, such as “from: Angie; attachment: .jpg; date: April 1.” The natural language processing will attempt to derive search parameters regardless of the particular syntax or structure of the text input.

In some implementations, the natural language text input corresponds to a transcribed speech input. For example, a user will initiate a speech-to-text and/or voice transcription function, and will speak the words that they wish to appear in the text input field. The spoken input is transcribed to text and displayed in the text input field (e.g., the text input field 404, FIG. 4A).

The electronic device processes the natural language text input to derive search parameters for a document search (306). In some implementations, the natural language processing is performed by the natural language processing module 230, described above with respect to FIG. 2. The search parameters include one or more document attributes and one or more values corresponding to each document attribute. In some implementations, natural language processing uses predetermined rules and/or templates to determine the search parameters. For example, one possible template is the phrase “sent on” (or a synonym thereof) followed by a date indicator (e.g., “Thursday,” or “12/25”). Thus, the NLP module 230 determines that the user intended a search parameter limiting the documents to those that were sent on a particular date.

Document attributes describe characteristics of documents, and are each associated with a range of possible values. Non limiting examples of document attributes include document type (e.g., email, word processing document, notes, calendar entries, reminders, instant messages, IMESSAGES, images, photographs, movies, music, podcasts, audio, etc.), associated dates (e.g., sent on, sent before, sent after, sent between, received on/before/after/between, created on/before/after/between, edited on/before/after/between, etc.), attachments (e.g., has attachment, no attachment, type of attachment (e.g., based on file extension), etc.), document location (e.g., inbox, sent mail, a particular folder or folders (or other logical address), entire hard drive), and document status (e.g., read, unread, flagged for follow up, high importance, low importance, etc.). Document attributes also include field restriction operators, which limit the results of a search to those documents that have a requested value (e.g., a user-defined value) in a specific field of the document. Non limiting examples of field restriction operators include “any,” “from,” “to,” “subject,” “body,” “cc,” and “bcc.” For example, a search can be limited to emails with the phrase “birthday party” in the “subject” field. The foregoing document attributes are merely exemplary, and additional document attributes are also possible. Moreover, additional or different words may be used to refer to the document attributes described above.

A value corresponding to a document attribute corresponds to the particular constraint(s) that the user wishes to be applied to that attribute. In some implementations, values are words, numbers, dates, Boolean operators (e.g., yes/no, read/unread, etc.), email addresses, domains, etc. A specific example of a value for a document attribute of “type” is “email,” and for an attribute of “received on” is “April.” Other examples of values include Boolean operators, such as where a document attribute has only two possible values (e.g., read/unread, has attachment/does not have attachment). Values of field restriction operators are any value(s) that may be found in that field. For example, the field restriction operator “To” may be used to search for emails that have a particular recipient in the “To” field. A value associated with this field restriction, then, may be an email address, a person's name, a domain (e.g., “apple.com”), etc. A value associated with a field restriction operator of “body” or “subject,” for example, may be any word(s), characters, etc.

Returning to step (306), the one or more document attributes and the one or more values corresponding to each document attribute are derived from the natural language text input. For example, as shown in FIG. 4A, a user enters the text string “Find emails from Angie sent on April 1 that have jpgs,” and the electronic device derives the document attributes 406a-d and values 408a-d, which include the following attribute-value pairs: “type: email,” “from: Angie,” “date sent: April,” and “attachments: Attachment contains *.jpg.”

In some implementations, the electronic device performs the natural language processing locally (e.g., on the client computer system 102). However, in some implementations, the electronic device sends the natural language text input to a server system remote from the electronic device (308) (e.g., the server computer system 104). The electronic device then receives the search parameters (including the one or more document attributes and one or more values corresponding to the document attributes) from the remote server system (310).

The electronic device displays, in a display region different from the text input field, the one or more document attributes and the one or more values corresponding to each document attribute (312). Referring again to FIG. 4A, the derived document attributes 406a-d and values 408a-d are displayed in a display region 410 that is different from the text input field 404. While the display region is different from the text input field, it may share one or more common borders with the text input field. In some implementations, the display region 410 appears as a popup window near the text input field, as illustrated in FIG. 4A. Accordingly, both the original natural language input and the derived search parameters are displayed to the user. Accordingly, as the user can see precisely how their search request has been parsed by the natural language processor, and is not left guessing what document attributes and values are actually being used to perform the search. Moreover, as discussed below, the user can then make changes to the search parameters in order to refine the search and/or document result set without editing the existing natural language input (or entering a new one).

In some implementations, the electronic device displays identifiers of the one or more identified documents on the display device (316) (e.g., the search results). In some implementations, the identifiers are links to and/or icons representing the identified documents. The document identifiers are displayed in any appropriate manner, such as in an instance of a file manager, an application environment (e.g., as a list in an email application), or the like.

In some implementations, both the processing of the natural language text input and the displaying of the one or more document attributes and the one or more values begin prior to receiving the end of the natural language text input. For example, as shown in FIG. 4B, the partial text string “Find emails from Angie . . . ” has been entered in the text input field 404, such as would occur sometime prior to the completion of the text string shown in FIG. 4A. As shown, even though the text string has only partially been entered, the document attributes “type” and “from” (406a and 406b) and the values “email” and “Angie” (408a and 408b) are already displayed in the display region 410. Thus, search parameters are derived and displayed as the user types them, and without requiring an indication that the user has finished entering the text string (e.g., by pressing the “enter” key or selecting search button/icon).

In some implementations, the electronic device receives a user input corresponding to a request to delete one of the document attributes or one of the values (318). In some implementations, the request corresponds to a selection of an icon or other affordance on the display device (e.g., with a mouse click, touchscreen input, keystroke, etc.). For example, FIG. 4A illustrates a cursor 412 selecting a delete icon 414 associated with the document attribute “attachments.” After the delete icon 414 has been selected by the cursor (or any other selection method), the document attribute 406d and its corresponding value 408d will be removed. This may occur, for example, if a user sees a result set from the initial search, and decides to broaden the search by removing that particular document attribute and value.

In some implementations, the electronic device receives a user input corresponding to a request to edit one of the document attributes or one of the values (320). In some implementations, the user input is a selection of an edit icon or other affordance, or a selection of (or near) the text of the displayed document attribute or corresponding value (e.g., with a mouse click, touchscreen input, keystroke, etc.) For example, FIG. 4C illustrates a cursor 412 having selected the value 408b associated with the “from” document attribute. In response to the selection, the derived value is shown in a text input region so that it can be edited. Editing a value includes editing the existing value as well as adding additional values. As shown in the figure, the user has edited the name “Angie” by replacing it with the full name “Angela.”

Attention is directed to FIG. 3B, which illustrates additional aspects of the method 300. The steps in FIG. 3B are also described with reference to FIGS. 4D-E, which illustrate exemplary user interfaces corresponding to steps (322)-(330) of method 300.

In some implementations, the electronic device receives a user input corresponding to a request to add an additional document attribute (322). The request corresponds to a selection of an icon or other affordance (e.g., selectable text) on the display device (e.g., with a mouse click, touchscreen input, keystroke, etc.). For example, FIG. 4D illustrates an add button 416 displayed in the display region 410. The add button 416 has been selected by a user, as shown by the cursor 412-1.

In some implementations, in response to the user input requesting to add the additional document attribute, the electronic device displays a list of additional document attributes (324). The additional document attributes include any of the document attributes listed above, as well as any other appropriate document attributes. FIG. 4D shows a list of additional document attributes displayed in the display region 420. (The display region 420 appeared in response to the selection of the add button 416.) In some implementations, the set of additional document attributes that is displayed depends on a value of another document attribute that has already been selected. For example, when a search is limited to documents of the type “email,” a set of document attributes that are appropriate for emails is displayed (e.g., read status, to, bcc, etc.), which may be different from the set that is displayed when searching for documents of the type “photograph” (which includes, for example, capture date, camera type, etc.). In some implementations, the display region 420 appears as a popup window near the display region 410 (and/or near the add button 416).

In some implementations, the electronic device receives a selection (e.g., a mouse click, touchscreen input, etc.) of one of the displayed additional document attributes (326). For example, FIG. 4D shows a document attribute “body contains the word(s)” being selected by the cursor 412-2.

In some implementations, the electronic device displays the selected additional document attribute in the display region (328). For example, FIG. 4E illustrates the selected additional document attribute 406e in the display region 410, along with the document attributes 406a-d that were already displayed as a result of the natural language processing of the text input.

In some implementations, the electronic device receives an additional value corresponding to the selected additional document attribute (330). For example, when the additional document attribute is displayed in the display region 410, a text input field associated with the additional document attribute is also displayed so that the user can enter a desired value (e.g., with a keyboard, text-to-speech service, or any other appropriate text input method). FIG. 4E illustrates a text input field associated with value 408e displayed beneath the document attribute 406e, in which a user has typed the value “vacation.” Thus, the document search will attempt to locate emails that have the word “vacation” in the body.

In some implementations, preconfigured values are presented to the user instead of a text input field, and the user simply clicks on or otherwise selects one or more of the preconfigured values. If a user selects the document attribute “read status,” for example, selectable elements labeled “read” and “unread” are displayed so that the user can simply click on (or otherwise select) the desired value without having to type in the value. This is also beneficial because the user need not know the specific language that the search function uses for certain document attributes (e.g., whether the search function expects “not read” or “unread” as the value).

In some implementations, the electronic device searches a document repository to identify one or more documents satisfying the one or more document attributes and the corresponding one or more values (332). In some implementations, the search is performed by the document search module 232 (FIG. 2), and the document repository is the document repository 234 (FIG. 2). (As noted above, the document repository 234 may be local to the electronic device at which the search string was entered, or it may be remote from that device.) For example, in some implementations, the document repository 234 and the search module 232 are both located on the client computer 102 (e.g., corresponding to one or more file folders or any other logical addresses on a local storage drive). In some other implementations, the document repository 234 is located on the server computer system 104, and the search module 232 is located on the client computer 102. In some implementations, the document repository 234 and the search module 232 are both located on the server computer 104. Thus, the search function described herein can search for documents that are stored locally and/or remotely. In some implementations, the user can limit the search to a particular document repository or subset of a document repository, such as by reciting a particular document location (e.g., “search ‘Sent Mail’ for emails about sales projections”).

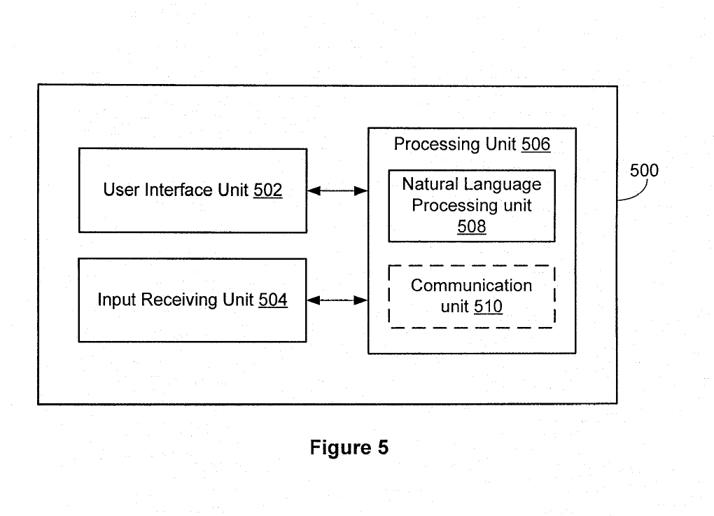

In accordance with some implementations, FIG. 5 shows a functional block diagram of an electronic device 500 configured in accordance with the principles of the invention as described above. The functional blocks of the device may be implemented by hardware, software, or a combination of hardware and software to carry out the principles of the invention. It is understood by persons of skill in the art that the functional blocks described in FIG. 5 may be combined or separated into sub-blocks to implement the principles of the invention as described above. Therefore, the description herein may support any possible combination or separation or further definition of the functional blocks described herein.

As shown in FIG. 5, the electronic device 500 includes a user interface unit 502 configured to display a text input field on a display device associated with the electronic device. The electronic device 500 also includes an input receiving unit 504 configured to receive a natural language text input entered into the text input field. In some implementations, the input receiving unit 504 is configured to receive other inputs as well. The electronic device 500 also includes a processing unit 506 coupled to the user interface unit 502 and the input receiving unit 504. In some implementations, the processing unit 506 includes a natural language processing unit 508. In some implementations, the natural language processing unit 508 corresponds to the natural language processing module 230 discussed above, and is configured to perform any operations described above with reference to the natural language processing module 230. In some implementations, the processing unit 506 includes a communication unit 510.

The processing unit 506 is configured to: process the natural language text input to derive search parameters for a document search (e.g., with the natural language processing unit 508), the search parameters including one or more document attributes and one or more values corresponding to each document attribute; and instruct the user interface unit to display, in a display region different from the text input field, the one or more document attributes and the one or more values corresponding to each document attribute.

In some implementations, the processing unit 506 is also configured to send the natural language text input to a server system remote from the electronic device (e.g., with the communication unit 510); and receive the search parameters from the server system (e.g., with the communication unit 510).

In some implementations, processing the natural language text input and displaying the one or more document attributes and the one or more values begins prior to receiving the end of the natural language text input.

In some implementations, the input receiving unit 504 is further configured to receive a first user input corresponding to a request to delete one of the document attributes or one of the values. In some implementations, the input receiving unit 504 is further configured to receive a second user input corresponding to a request to edit one of the document attributes or one of the values.

In some implementations, the input receiving unit 504 is further configured to receive a third user input corresponding to a request to add an additional document attribute. In some implementations, the processing unit 506 is further configured to, in response to the third user input, instruct the user interface unit 502 to display a list of additional document attributes; the input receiving unit 504 is further configured to receive a selection of one of the displayed additional document attributes; the processing unit 506 is further configured to instruct the user interface unit 502 to display the selected additional document attribute in the display region; and the input receiving unit 504 is further configured to receive an additional value corresponding to the selected additional document attribute.

In some implementations, the one or more document attributes include at least one field restriction operator. In some implementations, the field restriction operator is selected from the group consisting of: from; to; subject; body; cc; and bcc. In some implementations, the one or more document attributes are selected from the group consisting of: date sent; sent before; sent after; sent between; received before; received after; received between; attachment; read; unread; flagged; document location; and document status.

The foregoing description, for purpose of explanation, has been described with reference to specific implementations. However, the illustrative discussions above are not intended to be exhaustive or to limit the disclosed implementations to the precise forms disclosed. Many modifications and variations are possible in view of the above teachings. The implementations were chosen and described in order to best explain the principles and practical applications of the disclosed ideas, to thereby enable others skilled in the art to best utilize them with various modifications as are suited to the particular use contemplated.

It will be understood that, although the terms “first,” “second,” etc. may be used herein to describe various elements, these elements should not be limited by these terms. These terms are only used to distinguish one element from another. For example, a first sound detector could be termed a second sound detector, and, similarly, a second sound detector could be termed a first sound detector, without changing the meaning of the description, so long as all occurrences of the “first sound detector” are renamed consistently and all occurrences of the “second sound detector” are renamed consistently. The first sound detector and the second sound detector are both sound detectors, but they are not the same sound detector.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if' may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “upon a determination that” or “in response to determining” or “in accordance with a determination” or “upon detecting” or “in response to detecting” that the stated condition precedent is true, depending on the context.

What is claimed is:

1. A method for searching for documents, performed at an electronic device including a display device, one or more processors, and memory storing instructions for execution by the one or more processors, the method comprising:
displaying a text input field on the display device;
receiving a natural language text input in the text input field;
processing the natural language text input to derive search parameters for a document search, the search parameters including one or more document attributes and one or more values corresponding to each document attribute; and
displaying, in a display region different from the text input field, the one or more document attributes and the one or more values corresponding to each document attribute.

2. The method of claim 1, wherein processing the natural language text input comprises:
sending the natural language text input to a server system remote from the electronic device; and
receiving the search parameters from the server system.

3. The method of claim 1, wherein processing the natural language text input and displaying the one or more document attributes and the one or more values begins prior to receiving the end of the natural language text input.

4. The method of claim 1, further comprising receiving a first user input corresponding to a request to delete one of the document attributes or one of the values.

5. The method of claim 1, further comprising receiving a second user input corresponding to a request to edit one of the document attributes or one of the values.

6. The method of claim 1, further comprising receiving a third user input corresponding to a request to add an additional document attribute.

7. The method of claim 6, further comprising:
in response to the third user input, displaying a list of additional document attributes;
receiving a selection of one of the displayed additional document attributes;
displaying the selected additional document attribute in the display region; and
receiving an additional value corresponding to the selected additional document attribute.

8. The method of claim 1, wherein the one or more document attributes include at least one field restriction operator.

9. The method of claim 8, wherein the field restriction operator is selected from the group consisting of: from; to; subject; body; cc; and bcc.

10. The method of claim 1, wherein the one or more document attributes are selected from the group consisting of: date sent; sent before; sent after; sent between; received before; received after; received between; attachment; read; unread; flagged; document location; and document status.

11. An electronic device, comprising:
one or more processors;
memory; and
one or more programs, wherein the one or more programs are stored in the memory and configured to be executed by the one or more processors, the one or more programs including instructions for:
displaying a text input field on the display device;
receiving a natural language text input in the text input field;
processing the natural language text input to derive search parameters for a document search, the search parameters including one or more document attributes and one or more values corresponding to each document attribute; and
displaying, in a display region different from the text input field, the one or more document attributes and the one or more values corresponding to each document attribute.

12. The electronic device of claim 11, wherein processing the natural language text input comprises:
sending the natural language text input to a server system remote from the electronic device; and
receiving the search parameters from the server system.

13. The electronic device of claim 11, wherein processing the natural language text input and displaying the one or more document attributes and the one or more values begins prior to receiving the end of the natural language text input.

14. The electronic device of claim 11, further comprising instructions for receiving a first user input corresponding to a request to delete one of the document attributes of one of the values.

15. The electronic device of claim 11, further comprising instructions for receiving a second user input corresponding to a request to edit one of the document attributes or one of the values.

16. The electronic device of claim 15, further comprising instructions for:
in response to the third user input, displaying a list of additional document attributes;
receiving a selection of one of the displayed additional document attributes;
displaying the selected additional document attribute in the display region; and
receiving an additional value corresponding to the selected additional document attribute.

17. The electronic device of claim 11, wherein the one or more document attributes include at least one field restriction operator.

18. The electronic device of claim 11, wherein the one or more document attributes are selected from the group consisting of: date sent; sent before; sent after; sent between; received before; received after; received between; attachment; read; unread; flagged; document location; and document status.

19. A graphical user interface on a multifunction device with a display, a memory, and one or more processors to execute one or more programs stored in the memory, the graphical user interface comprising:
a text input field;
wherein:
a natural language text input is received in the text input field;
the natural language text input is processed to derive search parameters for a document search, the search parameters including one or more document attributes and one or more values corresponding to each document attribute; and
in response to deriving the search parameters, a display region different from the text input field is displayed, the display region including the one or more document attributes and the one or more values corresponding to each document attribute.

20. A non-transitory computer readable storage medium storing one or more programs, the one or more programs comprising instructions, which when executed by an electronic device, cause the device to:
display a text input field on the display device;
receive a natural language text input in the text input field;
process the natural language text input to derive search parameters for a document search, the search parameters including one or more document attributes and one or more values corresponding to each document attribute; and
display, in a display region different from the text input field, the one or more document attributes and the one or more values corresponding to each document attribute.

21. An electronic device, comprising:
a user interface unit configured to display a text input field on a display device associated with the electronic device;
an input receiving unit configured to receive a natural language text input entered into the text input field; and
a processing unit coupled to the user interface unit and the input receiving unit, the processing unit configured to:
process the natural language text input to derive search parameters for a document search, the search parameters including one or more document attributes and one or more values corresponding to each document attribute; and
instruct the user interface unit to display, in a display region different from the text input field, the one or more document attributes and the one or more values corresponding to each document attribute.

22. The electronic device of claim 21, wherein processing the natural language text input comprises:
sending the natural language text input to a server system remote from the electronic device; and
receiving the search parameters from the server system.

23. The electronic device of claim 22, wherein processing the natural language text input and displaying the one or more document attributes and the one or more values begins prior to receiving the end of the natural language text input.

24. The electronic device of claim 21, wherein the input receiving unit is further configured to receive a first user input corresponding to a request to delete one of the document attributes or one of the values.

25. The electronic device of claim 21, wherein the input receiving unit is further configured to receive a second user input corresponding to a request to edit one of the document attributes or one of the values.
